(19) United States
(12) Patent Application Publication
(10) Pub. No.: US 2026/0161504 A1
(43) Pub. Date: Jun. 11, 2026

(54) SYSTEM AND METHOD FOR CORRECTING ERROR OF HIGH BANDWIDTH MEMORY

(71) Applicant: UIF (University Industry Foundation), Yonsei University, Seoul (KR)

(72) Inventors: Sung Ho Kang, Seoul (KR); Seung Ho Shin, Seoul (KR)

(21) Appl. No.: 19/408,931

(22) Filed: Dec. 4, 2025

(30) Foreign Application Priority Data
Dec. 5, 2024 (KR) 10-2024-0179546

(51) Int. Cl. G06F 11/10

(52) U.S. Cl. CPC G06F 11/1044

(57) ABSTRACT

Disclosed is a system for correcting errors of a high bandwidth memory. The system for correcting errors of a high bandwidth memory according to an embodiment of the present disclosure includes: a base die controller configured to search for a zero block of a data word of a first codeword including the data word and a metadata for the data word; a zero flag generator configured to, if one or more of the zero blocks are present, generate zero flag information that is information on whether the zero block is present and a position of the zero block; and a Hamming processor configured to generate a Hamming check bit for at least a portion of the data word and the zero flag information.

### CROSS-REFERENCE TO RELATED APPLICATION

The present application claims priority under 35 U.S.C. § 119(a) to Korean patent application number 10-2024-0179546 filed on Dec. 5, 2024, in the Korean Intellectual Property Office, the entire disclosure of which is incorporated herein by reference.

### BACKGROUND

### 1. Technical Field

The present disclosure relates to a system and a method for correcting errors of a high bandwidth memory.

### 2. Related Art

With the development of artificial intelligence (AI) technology, demand for high bandwidth memory is increasing as deeper neural networks require more operations and a large feature map. While the high bandwidth memory uses I/O interface and 3D stacking technology which support high bandwidth, each die has a characteristic of being vulnerable to errors due to high density memory. In order to solve this problem, an on-die error correction code (On-die ECC) is used to correct soft errors occurring in each die.

The disclosure of this section is to provide background information. Applicant does not admit that any information contained in this section constitutes prior art.

### SUMMARY

In the standard specification of the high bandwidth memory HBM3, a 304-bit codeword with 32-bit on-die ECC check bit added is used for 272-bit codeword data including CRC-16 check bit.

As an example of the on-die ECC used in the HBM3 specification, one 16-bit-based Reed Solomon (RS) (19, 17) engine or two 8-bit-based RS (19, 17) engines may be used as an RS-based on-die ECC.

In the case where one 16-bit-based engine is used, the original data word can be recovered only when an error occurring in a DRAM is included in one 16-bit symbol.

Though the example technologies focus on the reliability enhancement of the on-die ECC and methods for accessing each die, an approach to the correction of errors caused by a through silicon via (TSV) is insufficient.

The present disclosure provides a system and a method for correcting errors of a high bandwidth memory, which is capable of correcting even errors due to a TSV by using a zero block.

In aspects of the present disclosure, a system for correcting errors of a high bandwidth memory according to the embodiment of the present disclosure includes: a base die controller configured to search for a zero block of a data word of a first codeword including the data word and a metadata for the data word; a zero flag generator configured to, if one or more of the zero blocks are present, generate zero flag information that is information on whether the zero block is present and a position of the zero block; and a Hamming processor configured to generate a Hamming check bit for at least a portion of the data word and the zero flag information. The base die controller may generate a second codeword obtained by replacing the zero block within the data word of the first codeword with the metadata and the Hamming check bit.

According to the embodiment of the present disclosure, the second codeword may be obtained by replacing the metadata with the zero flag information, and the base die controller may transmit the second codeword to a memory die.

According to the embodiment of the present disclosure, the memory die may include: an RS engine which is a Reed Solomon-based error correction module; and a zero masking unit. If a symbol error derived by the RS engine occurs in any one of the zero blocks, the zero masking unit may mask the zero block where the symbol error occurs with zero.

According to the embodiment of the present disclosure, the base die controller may correct, by using the Hamming check bit, errors of the codeword transmitted from the memory die.

According to the embodiment of the present disclosure, the base die controller may mask the zero block with zero and restores the zero block after correcting the errors by using the Hamming check bit, and may restore the first codeword by replacing the zero flag information with the metadata.

According to the embodiment of the present disclosure, the first codeword may include 256-bit data word and metadata that is a 16-bit cyclic redundancy check (CRC) check bit. The base die controller may search for a 16-bit zero block of a data word region for each first codeword divided into two parts. The zero flag information may include a zero mode 1 bit and a zero position 8 bit. If there is one zero block, the Hamming check bit may be generated for an upper 95-bit data word of the divided first codeword and the 9-bit zero flag information.

According to the embodiment of the present disclosure, the first codeword may include 256-bit data word and metadata that is a 16-bit cyclic redundancy check (CRC) check bit. The base die controller may search for a 16-bit zero block of a data word region for each first codeword divided into two parts. The zero flag information may include a zero mode 1 bit and a zero position 8 bit. If there are two or more zero blocks, the Hamming check bit may include a first Hamming check bit generated for an upper 68-bit data word of the divided first codeword and a second Hamming check bit generated for a lower 60-bit data word and 9-bit zero flag information.

Also, in aspects of the present disclosure, a method for correcting errors of the high bandwidth memory according to the embodiment of the present disclosure may be performed by the system correcting errors of the high bandwidth memory, which includes the base die controller, the zero flag generator, and the Hamming processor. The method may include: receiving, by the base die controller, a first codeword including a data word and a metadata for the data word; searching for, by the base die controller, a zero block of the data word; generating, if one or more of the zero blocks are present, by the zero flag generator, zero flag information that is information on whether the zero block is present and a position of the zero block; generating, by the Hamming processor, a Hamming check bit for at least a portion of the data word and the zero flag information; and generating, by the base die controller, a second codeword obtained by replacing the zero block within the data word of the first codeword with the metadata and the Hamming check bit.

### Advantageous Effects

The present disclosure has the effect of correcting even errors due to a TSV by using a zero block.

### BRIEF DESCRIPTION OF THE DRAWINGS

FIG. 1 shows a system for correcting errors of a high bandwidth memory according to an embodiment of the present disclosure.

FIG. 2 shows the system for correcting errors of the high bandwidth memory and operations thereof according to the embodiment of the present disclosure.

FIG. 3 shows a method for correcting errors of the high bandwidth memory according to the embodiment of the present disclosure.

FIG. 4 shows a method for correcting errors of the high bandwidth memory according to the embodiment of the present disclosure.

FIG. 5 shows a method for correcting errors of the high bandwidth memory according to the embodiment of the present disclosure.

### DETAILED DESCRIPTION

As the present disclosure can have various embodiments as well as can be diversely changed, specific embodiments will be illustrated in the drawings and described in detail. While the present disclosure is not limited to particular embodiments, all modification, equivalents and substitutes included in the spirit and scope of the present disclosure are understood to be included therein.

In the following description of the present disclosure, the detailed description of known technologies incorporated herein will be omitted when it may make the subject matter of the present disclosure unclear.

Hereinafter, embodiments of the present disclosure will be described in detail with reference to the accompanying drawings.

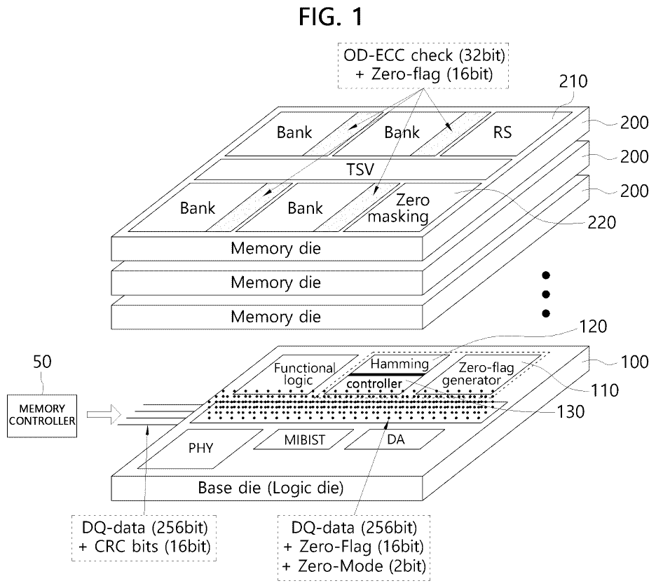

FIG. 1 shows a system for correcting errors of a high bandwidth memory according to the embodiment of the present disclosure.

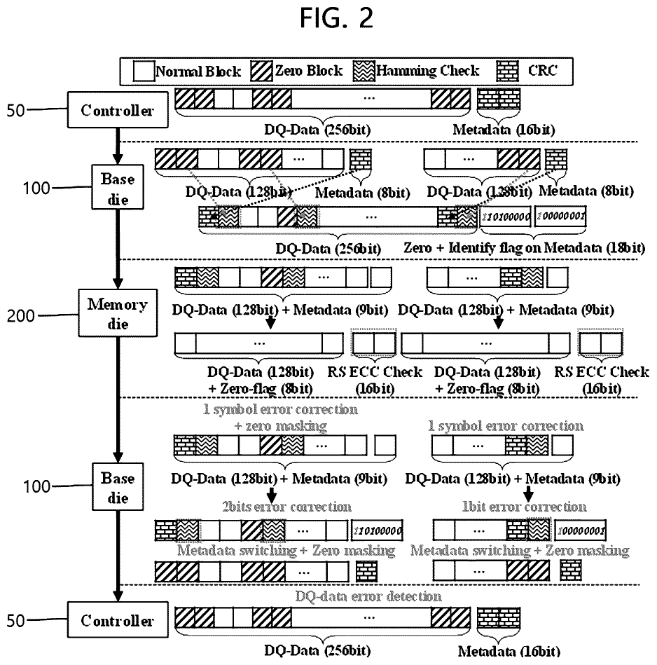

FIG. 2 shows the system for correcting errors of the high bandwidth memory and operations thereof according to the embodiment of the present disclosure.

Referring to FIGS. 1 and 2 together, the configuration and operation of the system for correcting errors of the high bandwidth memory will be described.

The system for correcting errors of the high bandwidth memory according to the embodiment of the present disclosure includes a zero flag generator 110, a Hamming processor 120, a base die controller 130, a Reed Solomon (RS) engine 210, and a zero masking unit 220.

The system for correcting errors of the high bandwidth memory according to the embodiment of the present disclosure may be particularly applied to write and read operations on the high bandwidth memory based on the HBM3 standard. However, the inventive concept of the present disclosure is not necessarily limited to operations according to the HBM3 standard.

The high bandwidth memory includes a base die 100 and a plurality of memory dies 200, and data transmission between the base die 100 and each memory die 200 is made using a through silicon via (TSV).

The zero flag generator 110, the Hamming processor 120, and the base die controller 130 may be installed in the base die 100, and the RS engine 210 and the zero masking unit 220 may be installed in each memory die 200.

Meanwhile, the operation of the present disclosure does not necessarily have to be performed by the same component. For example, the operation of the base die controller 130 may be processed by the zero flag generator 110.

The base die controller 130 receives a first codeword including a data word and a metadata from a memory controller 50.

The data word is 256-bit DQ data which is substantially stored in the memory. The metadata may be a 16-bit cyclic redundancy check (CRC) check bit for a 256-bit data word.

The base die controller 130 determines whether a zero block is included in the data word. Here, the first codeword may be divided into two parts, that is, 128-bit data word and 8-bit metadata. The divided codeword may be referred to as a first-first codeword and a first-second codeword. The first codeword is divided into the above unit because, when RS engines 19 and 17 which are Reed Solomon-based error correction code engines are used, ECC error checking for the first-first codeword and the first-second codeword is scheduled to be performed in two 8-bit based RS engines 19 and 17, respectively. The two RS engines 19 and 17 may independently correct an 8-bit error symbol. 19 means the total length of the codeword, and 17 means the length of a message. The two RS engines are used for error correction.

Hereinafter, if there is no special description, it will be understood as a description of the divided codeword.

The base die controller 130 determines whether the zero block is included in each of the first-first codeword and the first-second codeword. To search for the zero block may be to determine whether there is the zero block that is consecutive in 16 bit units in a data block divided in units of 8 bits. In FIG. 2, an 8-bit block is represented as one square. The zero block, a Hamming check bit, and a CRC-16 check bit are shown to be hatched in the forms of a diagonal line, a wave, and a brick, respectively.

The base die controller 130 generates a second codeword obtained by modifying the first codeword. The second codeword includes modified data for the zero block and zero flag information.

The zero flag generator 110 generates the zero flag information on whether the zero block is present and a position of the zero block. In the zero flag information, an upper 1 bit is information on whether the zero block is present. If the 1 bit is 1, there is present the zero block, and if the 1 bit is 0, there is no zero block.

The zero flag information is 9-bit information, and the upper 1 bit indicates whether the zero block is present, and lower 8 bits indicate the position of the zero block. However, if there is no zero block, 8 bits of metadata is recorded in the lower 8 bits.

The Hamming processor 120 generates a Hamming check bit for at least a portion of the data word.

The Hamming processor 120 does not generate the Hamming check bit if there is no zero block.

If there is one zero block, the Hamming processor 120 generates the Hamming check bit for an upper 95-bit data word (DQ data) and 9-bit zero flag information (total 104 bits).

Generating the Hamming check bit for 104 bits is required to meet the following conditions when using Hsiao code for hardware optimization.

1) H-matrix has no all-zero column

2) All the columns of H-matrix must be different

3) Each column has an odd number of 1s

4) The numbers of 1s of the rows of H-matrix must be the same

The Hamming check bit for up to 104 bits may be generated so as to satisfy the above conditions. In this case, a 1-bit error can be corrected. A correction target error of the Hamming check bit may be a TSV error.

If there are two or more zero blocks, the Hamming processor 120 generates the Hamming check bits for an upper 68-bit data word, a lower 60-bit data word, and 9-bit zero flag information, respectively. In this case, a 2-bit error can be corrected. The correction target error of the Hamming check bit may be a TSV error.

The base die controller 130 may replace a portion of the zero block of the first codeword with metadata, and may replace another portion with the Hamming check bit. Also, 8-bit metadata of the first codeword may be replaced with the 9-bit zero flag information. Specifically, the first-first codeword is converted into a second-first codeword including a 128-bit data word and the 9-bit zero flag information, and the first-second codeword is converted into a second-second codeword including the 128-bit data word and the 9-bit zero flag information. The data word of the second codeword may include a block in which the zero block is replaced with the Hamming check bit and metadata.

In the example of FIG. 2, the data word of the first-first codeword includes two zero blocks, and the data word of the first-second codeword includes one zero block.

The base die 100 generates the Hamming check bits for a 68-bit upper data word, a 60-bit lower data word, and the 9-bit zero flag information out of the first-first codeword, respectively. The base die 100 replaces upper 8 bits of the first zero block with metadata, and replaces lower 8 bits with one of the two generated Hamming check bits and lower 8 bits of the second zero block with the other one of the two generated Hamming check bits. Upper 8 bits of the second zero block are left as they are.

The base die 100 generates the 9-bit zero flag information on the first-first codeword. The zero flag information may be 11010000. This means that the zero block is present in the first and third 16-bit blocks.

The base die 100 generates the second-first codeword including 128-bit data obtained by replacing a portion of the zero blocks of the first-first codeword with the Hamming check bit and metadata and the 9-bit zero flag information, and transmits the second-first codeword to the memory die 200.

The base die 100 generates the Hamming check bits for a 96-bit upper data word and 8-bit metadata out of the first-second codeword. The base die 100 replaces upper 8 bits of the zero block with metadata and replaces lower 8 bits with the generated Hamming check bit.

The base die 100 generates the 9-bit zero flag information on the first-second codeword. The zero flag information may be 10000001. This means that the zero block is present in the eighth 16-bit block.

The base die 100 generates the second-second codeword including 128-bit data obtained by replacing the zero block of the first-second codeword with the Hamming check bit and the metadata and the 9-bit zero flag information, and transmits the second-second codeword to the memory die 200.

Generating the second codeword and transmitting the second codeword to the memory die 200 may mean a write operation to the memory.

The memory die 200 may each include two RS engines 210. The memory die 200 may further include the zero masking unit 220.

The RS engine 210 generates a third codeword by adding a 16-bit ECC check bit to the second codeword during a write operation. The second-first codeword and the second-second codeword are stored respectively as a third-first codeword and a third-second codeword including 128-bit DQ data, the 9-bit zero flag information, and the 16-bit ECC check bit.

During a read operation, the RS engine 210 corrects errors for 128 bits excluding 1-bit information indicating whether the zero block is present among the third-first codeword and the third-second codeword and for 136 bits for 8-bit zero flag information, respectively.

After correcting errors, the memory die 200 transmits the second-first codeword and the second-second codeword of 137 bits (128 bits+9 bits) excluding the ECC check bit to the base die 100.

In the meantime, if a symbol error occurs at the position of the zero block, which is not replaced with the Hamming check bit or metadata when there are two or more zero blocks, the zero masking unit 220 may correct the symbol error by masking the symbol with zero. According to the position of the error, if the symbol error is masked with zero, the two symbol errors are reduced to one symbol error, thereby enhancing the performance of the RS engine.

During the read operation, the second-first codeword and the second-second codeword are transmitted from the memory die 200 to the base die 100. Each of the second-first codeword and the second-second codeword may be obtained by that the RS engine 210 corrects errors or by that the zero masking unit 220 corrects the zero block error.

The base die controller 130 corrects a maximum 2-bit error by using the Hamming check bit included in the second codeword. The error may be a TSV transmission error.

In the example of FIG. 2, the base die controller 130 corrects the 2-bit error for the 128-bit data word and the 9-bit zero flag information using two Hamming check bits included in the second-first codeword.

The base die controller 130 corrects a 1-bit error for the upper 95-bit data word and the 9-bit zero flag information using one Hamming check bit included in the second-second codeword.

During the error correction, the position of the Hamming check bit may refer to the zero flag information.

After correcting the TSV error, the base die controller 130 restores the original data word by masking the zero block of the second codeword. The base die controller 130 restores the 9-bit zero flag information to metadata simultaneously or sequentially or in a changed order.

Specifically, the base die controller 130 masks all the two zero blocks of the second-first codeword with zero, and restores the first-first codeword by restoring the metadata written to the upper 8 bits of the first zero block. The base die controller 130 masks one zero block of the second-second codeword with zero, and restores the first-second codeword by restoring the metadata written to the upper 8 bits of the zero block.

The base die controller 130 connects the first-first codeword and the first-second codeword to transmit the first codeword including the 256-bit data word and 16-bit CRC check data to the memory controller 50.

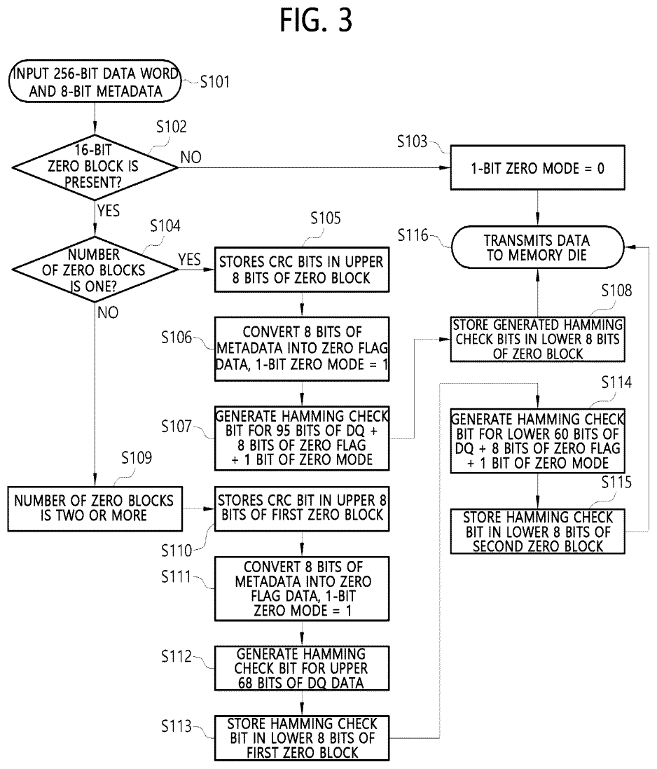

FIGS. 3 to 5 show a method for correcting errors of the high bandwidth memory according to the embodiment of the present disclosure. The method for correcting errors of the high bandwidth memory according to the embodiment of the present disclosure will be described as being implemented by the system for correcting errors of the high bandwidth memory according to the embodiment of the present disclosure.

FIG. 3 shows operations of the base die 100 when writing to a memory.

Referring to FIG. 3, in step S101, the base die 100 receives the first codeword including a 256-bit data word and 16-bit metadata. Here, only the first-first codeword including the divided 128-bit data word and 8-bit metadata will be described.

In step S102, the base die 100 determines whether the zero block is present in the data word of the first-first codeword. If the zero block is present, step S104 is performed, and if not present, step S103 is performed.

In step S103, the base die 100 generates the second-first codeword including the zero flag information where 1-bit zero mode=0 is written. Here, the second-first codeword includes the 128-bit data word and the 9-bit zero flag information, and the zero flag information includes 1-bit zero mode data and 8-bit metadata.

In step S104, the base die 100 determines whether the number of zero blocks is one or two or more. If there is one zero block, step S105 is performed, and if there are two or more zero blocks, step S109 is performed.

In step S105, the base die 100 stores 8 bits of the CRC-16 check bits as metadata, in the upper 8 bits of the zero block.

In step S106, the base die 100 replaces the metadata with the zero flag information which includes 1-bit zero mode=1 and position data indicating the position of 8-bit zero block.

In step S107, the base die 100 generates the Hamming check bit for 95 bits of the DQ data and the 9-bit zero flag information.

In step S108, the base die 100 stores the generated Hamming check bits in the lower 8 bits of the zero block. Then, step S116 is performed.

If there is one zero block, the second-first codeword includes the 128-bit DQ data obtained by converting the zero block into metadata and Hamming check bits, and the 9-bit zero flag information.

In step S109, if the number of zero blocks is two or more, step S109 is performed.

Steps S110 to S115 describe a case in which the number of zero blocks is two. If the number of zero blocks is three or more, the second zero block is processed in the same manner, and the third and subsequent zero blocks are maintained as they are.

In step S110, the base die 100 stores the CRC bit in the upper 8 bits of the first zero block.

In step S111, the base die 100 replaces the metadata with the zero flag information which includes 1-bit zero mode=1 and position data indicating the position of 8-bit zero block. The second-first codeword includes the 128-bit DQ data obtained by converting the zero block into metadata and Hamming check bits, and the 9-bit zero flag information.

In step S112, the base die 100 generates the first Hamming check bit for the upper 68 bits of the DQ data.

In step S113, the base die 100 stores the generated first Hamming check bit in the lower 8 bits of the first zero block.

In step S114, the base die 100 generates the second Hamming check bit for the lower 60 bits of the DQ data and the 9-bit zero flag information.

In step S115, the base die 100 stores the second Hamming check bit in the lower 8 bits of the second zero block.

If there are two or more zero blocks, the second-first codeword includes the 128-bit DQ data obtained by converting the first zero block into metadata and the first Hamming check bit and by converting the lower 8 bits of the second zero block into the second Hamming check bit, and the 9-bit zero flag information.

In step S116, the base die 100 transmits the second-first codeword to the memory die 200.

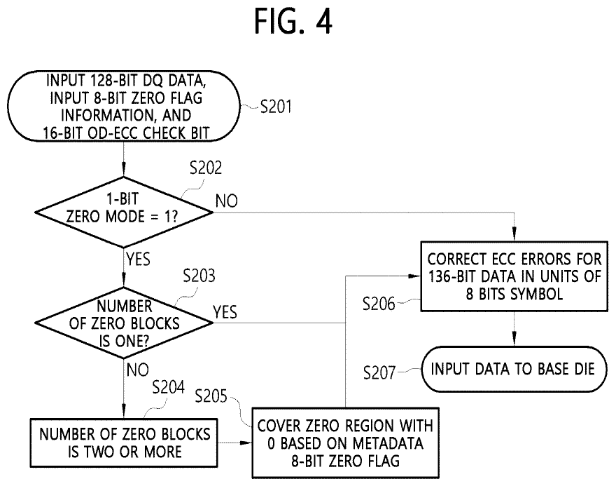

FIG. 4 shows operations of the memory die 200 when reading from the memory. It is premised that, in the memory die 200 during the write operation, the 16-bit ECC check bit is additionally stored in the second-first codeword.

Referring to FIG. 4, in step S201, the memory die 200 inputs the 128-bit DQ data, the 8-bit zero flag information other than the zero mode information, and the 16-bit ECC check bit from the second-first codeword to the RS engine 210.

The zero mode information is used to determine the branch and may not be used for error checking.

In step S202, the memory die 200 determines whether the 1-bit zero mode is 1. If the 1-bit zero mode is 1, step S203 is performed, and if the 1-bit zero mode is 0, step S206 is performed.

In step S203, the memory die 200 determines whether the number of zero blocks is one. If the number is one, step S206 is performed, and if not one, step S204 is performed.

In step S204, the memory die 200 determines whether the number of zero blocks is two or more. If the number is two or more, step S205 is performed.

In step S205, the memory die 200 masks the zero block with 0 based on the zero flag information, and excludes a region replaced with metadata or Hamming check bit. For example, the first zero block of the second zero blocks may be masked with 0. For example, if there is a fourth zero block, all the zero blocks may be masked with 0.

In step S205, if an error occurs in the zero block replaced with the metadata or the Hamming check bit, there is an effect in which the error is corrected. Accordingly, even though errors in two or more symbols is inherently generated, if the errors are overcome by step S205 and reduced to one symbol error, error correction is made possible by the RS engine 210.

In step S206, the RS engine 210 corrects errors for the 128-bit DQ data and 136-bit data for the 8-bit zero flag information in units of 8-bit symbols. The RS 19 and 17 is able to correct one symbol error. As described above, in step S205, if errors in one or more symbols are overcome by zero masking, there may occur a case where errors in two or more symbols can also be corrected.

In step S207, the memory die 200 transmits the error-corrected second-first codeword to the base die 100. Here, a TSV error may occur.

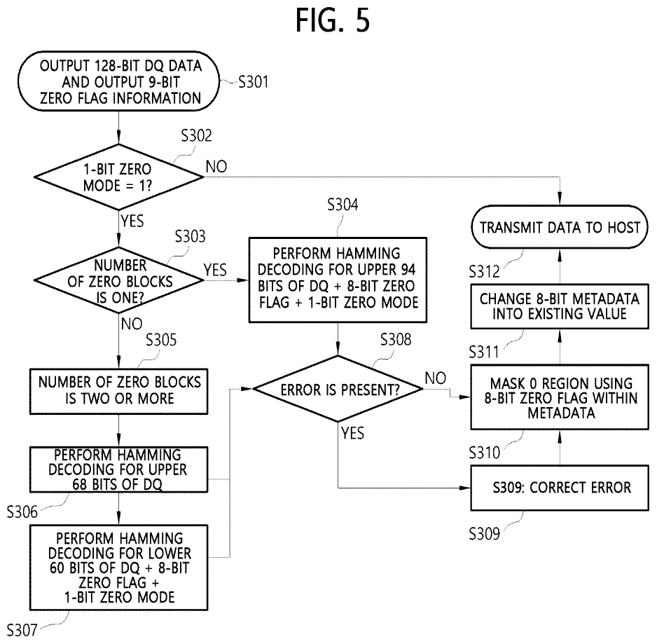

FIG. 5 shows operations of the base die 100 when reading from the memory.

Referring to FIG. 5, in step S301, the memory die 200 outputs the second-first codeword including the 128-bit DQ data and the 9-bit zero flag information to the base die 100.

In step S302, the base die 100 determines whether the 1-bit zero mode is 1. If the 1-bit zero mode is 1, step S303 is performed, and if not 1, step S312 may be performed.

In step S303, the base die 100 determines whether the number of zero blocks is one. If the number is one, step S304 is performed, and if not one, step S305 is performed.

In step S304, Hamming decoding is performed using the Hamming check bit for upper 95 bits of the DQ data and the 9-bit zero flag information. Then, step S308 is performed.

In step S305, the base die 100 determines whether the number of zero blocks is two or more. If the number is two or more, step S306 is performed.

In step S306, the base die 100 performs Hamming decoding by using the first Hamming check bit for the upper 68 bits of the DQ data.

In step S307, the base die 100 performs Hamming decoding by using the second Hamming check bit for the lower 60 bits of the DQ data and the 9-bit zero flag information.

In step S308, the base die 100 determines whether an error is present as a result of performing the Hamming decoding. If there is an error, step S309 is performed, and if there is no error, step S310 is performed.

In step S309, the base die 100 corrects the error using the Hamming check bit.

In step S310, the base die 100 may mask the zero block with 0 and restore the zero block using the 8-bit zero flag information written at the position of the metadata in the first-first codeword.

In step S311, the base die 100 restores the first-first codeword by writing and restoring the original metadata at the position of the metadata of the first-first codeword.

The base die 100 connects the restored first-first codeword and the first-second codeword to restore the first codeword composed of 256-bit DQ data and 16-bit metadata (CRC check bits).

In step S312, the base die 100 transmits the first codeword including the restored 256-bit DQ data and 16-bit metadata to a host.

Terms used in the present specification are provided for description of only specific embodiments of the present disclosure, and not intended to be limiting. In the present specification, it should be understood that the term “include” or “comprise” and the like is intended to specify characteristics, numbers, steps, operations, components, parts or any combination thereof which are mentioned in the specification, and intended not to previously exclude the possibility of existence or addition of at least one another characteristics, numbers, steps, operations, components, parts or any combination thereof.

What is claimed is:

1. A system for correcting errors of a high bandwidth memory, the system comprising:
a base die controller configured to search for a zero block of a data word from among a first codeword, the first codeword including the data word and metadata for the data word;
a zero flag generator configured to, if one or more of the zero blocks are present, generate zero flag information that is information on whether the zero block is present and a position of the zero block; and
a Hamming processor configured to generate a Hamming check bit for at least a portion of the data word and the zero flag information,
wherein the base die controller generates a second codeword obtained by replacing the zero block within the data word of the first codeword with the metadata and the Hamming check bit.

2. The system of claim 1,
wherein the second codeword is obtained by replacing the metadata with the zero flag information, and
wherein the base die controller transmits the second codeword to a memory die.

3. The system of claim 2, wherein the memory die comprises:
an RS engine which is a Reed Solomon-based error correction module; and
a zero masking unit,
wherein, if a symbol error derived by the RS engine occurs in any one of the zero blocks, the zero masking unit masks the zero block where the symbol error occurs with zero.

4. The system of claim 2, wherein the base die controller corrects, by using the Hamming check bit, errors of the codeword transmitted from the memory die.

5. The system of claim 4, wherein the base die controller masks the zero block with zero and restores the zero block after correcting the errors by using the Hamming check bit, and restores the first codeword by replacing the zero flag information with the metadata.

6. The system of claim 1,
wherein the first codeword comprises 256-bit data word and metadata that is a 16-bit cyclic redundancy check (CRC) check bit,
wherein the base die controller searches for a 16-bit zero block of a data word region for each first codeword divided into two parts,
wherein the zero flag information comprises a zero mode 1 bit and a zero position 8 bit, and
wherein, if there is one zero block, the Hamming check bit is generated for an upper 95-bit data word of the divided first codeword and the 9-bit zero flag information.

7. The system of claim 1,
wherein the first codeword comprises 256-bit data word and metadata that is a 16-bit cyclic redundancy check (CRC) check bit,
wherein the base die controller searches for a 16-bit zero block of a data word region for each first codeword divided into two parts,
wherein the zero flag information comprises a zero mode 1 bit and a zero position 8 bit, and
wherein, if there are two or more zero blocks, the Hamming check bit comprises a first Hamming check bit generated for an upper 68-bit data word of the divided first codeword and a second Hamming check bit generated for a lower 60-bit data word and 9-bit zero flag information.

8. A method in which the system correcting errors of a high bandwidth memory, which comprises the base die controller, the zero flag generator, and the Hamming processor, corrects errors of the high bandwidth memory, the method comprising:
receiving, by the base die controller, a first codeword including a data word and a metadata for the data word;
searching for, by the base die controller, a zero block of the data word;
generating, if one or more of the zero blocks are present, by the zero flag generator, zero flag information that is information on whether the zero block is present and a position of the zero block;
generating, by the Hamming processor, a Hamming check bit for at least a portion of the data word and the zero flag information; and
generating, by the base die controller, a second codeword obtained by replacing the zero block within the data word of the first codeword with the metadata and the Hamming check bit.
